(19) United States
(12) Patent Application Publication
(10) Pub. No.: US 2003/0059587 A1
(43) Pub. Date: Mar. 27, 2003

(54) Composite nonwoven fabric having great crosswise tensile strength, method for its production and use

(76) Inventors: Hansjorg Grimm, Weinheim (DE); Dieter Groitzsch, Hirschberg (DE); Marc Pehr, Laudenbach (DE)

Correspondence Address: KENYON & KENYON, ONE BROADWAY, NEW YORK, NY, 10004, US

(21) Appl. No.: 10/196,765

(22) Filed: Jul. 17, 2002

(30) Foreign Application Priority Data
Jul. 19, 2001 (DE) 101 35 111.9

(51) Int. Cl. B32B 3/00; B32B 27/14; B32B 5/06; D04H 3/14

(52) U.S. Cl. 428/196; 428/198; 442/381; 442/389; 442/409; 156/85; 156/250

(57) ABSTRACT

A composite material, including at least one nonwoven fabric and a reinforcing material, thermally connected to it, situated in the form of regularly recurring patterns, which is derived from sheeting made of thermoplastic material. The new composite material may be used, for example, as an operating room coat, a textile outer material for one-time use, as a belt or in absorbent products, such as diapers or feminine hygiene products.

### BACKGROUND OF THE INVENTION

1. Field of the Invention

The invention relates to a new nonwoven fabric composite which may be used particularly for an operating room coat, disposable textile outer material, for a belt or in absorbent materials.

2. Description of Related Art

It is generally known that staple fiber nonwoven fabrics in particular frequently have the disadvantage of having low strength transversely to the machine running direction, since their fibers are aligned more or less greatly in the machine running direction. Such great longitudinal orientations appear when the strippers are positioned above the fiber lay-up bands, which is the case these days in most staple fiber nonwoven fabric production. In application cases where a fiber distribution as isotropic as possible is required or great mechanical strength in both directions, those staple fiber nonwoven fabrics are disadvantageous, whose longwise/crosswise ratios of breaking strength are in the range of about 3:1 to 10:1. Getting around this by going to conventional spunbonded nonwoven fabrics, which, as is known, have more balanced longwise/crosswise ratios of breaking strength of ca. 1:1 to ca. 2:1 depending on the kind or modification of the spunbonding method, is not acceptable in most cases, since when using these continuous filament nonwoven fabrics, as a rule, one may not achieve comparable haptic or textile properties.

The methods of bonding applications known per se, in principle do not make any difference in the longwise/crosswise ratio in the breaking strength of nonwoven fabrics, even when not full coating but printing methods are used, having crosswise oriented printing patterns. That way, of course, increases in breaking strength are achieved. However, the increases with reference to longwise and crosswise tensile strengths are percentage-wise essentially the same, so that the longwise/crosswise ratio does not change thereby. Even when full smooth or patterned embossing calender bonds, using heat and pressure or ultrasound, are used, no more favorable ratios with regard to longwise/crosswise tensile strength may be produced.

It is known that nonwoven fabrics may be reinforced using netting, woven fabrics, knitted fabrics or interlaid scrim, and these can be designed, in this connection, in such a way that, on an absolute basis the crosswise tensile strength is increased more than the longitudinal tensile strength. Examples of nonwoven composite materials are given in “Nonwoven Fabrics: Raw Materials, Production, Uses, Properties, Testing”. Publishers: W. Albrecht, H. Fuchs, W. Kittelmann (Wiley-VHH, Weinheim, N.Y., 2000), Chapter 6.6.1 (Nonwoven Composite Fabrics), pp. 389-396.

The production of known composite materials is a lot of trouble and expensive, especially if, in addition to the layer reinforcing the nonwoven fabric, adhesives or bonding agents are required. But even if two fiber web layers are autogenously, i.e. without a further bonding agent, bonded to each other by the reinforcing layer, still, the reinforcing layer excessively drives up the cost of the composite material.

Compared to netting, woven fabrics, knitted fabrics or interlaid scrim, monolithic, i.e. non-microscopic sheeting, especially if it is made of polyolefin thermoplastics, is especially reasonable pricewise. Composite materials made of nonwovens and sheeting are also known. However, such composite may have numerous disadvantages, depending on the field of application being considered. Sheeting tends to promote rustling (the formation of noise from movements during use), lessen the textile properties considerably compared to nonwoven fabric alone, and prevent permeability to the most different media, such as air, gases and liquids such as water or organic solvents or vapors, such as water vapor.

The use of an impermeable (and pricewise reasonable) sheeting in a laminate, when applied to a nonwoven fabric laminate, as is known, leads to tensile strength reinforcement, but it has the disadvantage that the haptic and/or textile properties are clearly made worse, that the stiffness is increased, and the passage of air, water vapor and possibly other gases to the outside is strongly reduced, mostly to all the way to zero. This is especially true if a monolithic (i.e. pore-free) sheeting is used for the lamination. The stiffening of the laminate by the sheeting is particularly strongly characteristic if the sheeting is composed of a hard polymer, such as polypropylene, and the sheeting is fully bonded to the enclosing fabrics.

Thus, sheeting lamination to a nonwoven fabric is only appropriate if a barrier effect is desired. Thus, in the case of composite materials of nonwoven fabric and monolithic sheeting it is not possible to produce pervious structures such as breathing-active ones. However, to be sure, a clear increase in lateral tensile strength may be achieved with them. However, if the most cost-effective and most practiced extrusion coating (also called cast extrusion) is carried out directly from a sheeting die, the tensile strength increase is relatively modest because, as is known, stretching first leads to high sheeting tensile strength. Then again, a stretched sheeting cannot be applied to the nonwoven fabric directly from the die, but rather in a second, subsequent step (after stretching), and in most cases using an additional adhesive, such as hotmelt, will be required. This complicates the composite production some more, makes it costly, and still only leads to a completely impervious product.

### SUMMARY OF THE INVENTION

It is the object of the present invention to increase the tensile strength in a composite material having a principal proportion of nonwoven fabric by several times, at least in the direction crosswise to the machine running direction, while maintaining a high permeability of the composite produced.

These and other objects of the invention are achieved, according to one embodiment of the present invention, by a composite material comprising at least one nonwoven fabric and a reinforcing material, thermally connected to it, situated in the form of regularly recurring patterns, which is derived from sheeting made of thermoplastic material.

### BRIEF DESCRIPTION OF THE DRAWINGS

The present invention will be described in greater detail with reference to the following drawings wherein:

FIG. 1 describes a form of the composite material according to one embodiment of the present invention in a top view;

FIG. 2 shows schematically the cross section of the composite material of FIG. 1 along the line A-A;

FIG. 3 describes a manufacturing line for producing the composite material according to one embodiment of the present invention;

FIGS. 4a through 4j show different patterns of openings in the sheeting in the composite material according to one embodiment of the present invention;

FIGS. 5a through 5c describe surface shapes of the engravings; and

FIG. 6 describes the individual steps of the formation of regular openings in the sheeting in the composite material according to one embodiment of the present invention.

### DETAILED DESCRIPTION OF THE INVENTION

The present invention, according to one embodiment thereof, relates to a composite including at least one nonwoven fabric and a reinforcing material, thermally connected to it, in the form of regularly recurring patterns, which is derived from sheeting made of thermoplastic material.

The number of layers of the composite according to the present invention may be as high as desired, for example, two to six layers.

A composite material is preferred that has at least three layers in the sequence nonwoven fabric/reinforcement material/nonwoven fabric.

The fiber sheet used according to the present invention, which forms the nonwoven fabric, may be a spunbonded one or preferably a staple fiber nonwoven fabric. The web used according to the present invention, is made preferably of staple fibers oriented in the machine running direction.

The material of which the nonwoven fabric is made may be any kind. Examples for this are fibers of naturally occurring materials, such as cotton, or half synthetically produced fibers, such as cellulose fibers or particularly plastic fibers made of synthetic polymers, preferably made of polyester or polyamide.

The thermoplastic material of which the sheeting is made may likewise be any kind. Examples of this are thermoplastic polymers, such as polyamide, polyester or particularly polyolefins. In this context, homopolymers or copolymers may be involved, preferably polyethylene or most particularly preferably polypropylene.

Usually the sheeting used is a uniaxially or biaxially stretched sheeting.

In a further preferred specific embodiment, the nonwoven fabric is connected to the sheeting by heat sealing to at least one surface of the nonwoven fabric in the form of regularly recurring patterns, and at these locations on the surface of the nonwoven fabric, the sheeting remains intact, and at other locations on the surface of the nonwoven fabric the sheeting is no longer present as a result of tearing.

In the regularly recurring patterns of the heat sealed locations of nonwoven fabric and sheeting, preferably involved are regularly spaced lines or bars positioned perpendicular to and/or in the machine running direction.

In a further preferred specific embodiment of the regularly recurring pattern of the heat sealed locations of nonwoven fabric and sheeting, the latter is present in the form of evenly spaced lines in the form of hexagons.

The composite material according to the present invention may have any desired mass per unit area, such as in the range of 15 to 250 g/m². Especially preferred are types having mass per unit area of 20 to 150 g/m².

Due to the production method described below, the composite material according to the present invention may have a slight three-dimensional structure, i.e. one may find, with respect to the surface plane, alternatingly appearing elevations and depressions of slight height or depth.

Preferably the composite according to the present invention is essentially planar, and, with respect to the surface plane it has no alternatingly appearing elevations or depressions.

The composite material according to the present invention may be produced by a new method, in which, starting from a monolithic, biaxially, or at least monoaxially stretched sheeting crosswise to the machine running direction, this sheeting is converted, in the middle or at least in one surface of the composite material, during and/or after bonding to the nonwoven fabric in the form of a regularly applied pattern, preferably with the aid of calender bonding using special embossing, to an open fabric having perforations and sheeting components continuously bonded to one another, such as to sheet tapes or sheet netting structures.

The present invention relates, therefore, also to a method for producing the composite material described above, including these measures:

a) the combination of at least one fabric with a shrinkable sheeting of thermoplastic material,

b) heat sealing between the fabric and the shrinkable sheeting in the form of a regularly recurring pattern,

c) heating the composite thus obtained during or after step b) to a temperature at which the nonwoven fabric forms, the shrinkage of the shrinkable sheeting is released and, regularly with respect to the surface plane, alternatingly appearing elevations and depressions are formed,

d) stretching of the composite at least in one direction, so that the elevations and depressions essentially disappear, and the sheeting tears at the locations where it is not heat-sealed to the nonwoven fabric.

The method is based upon a weakening of the stretched sheeting at the edges of the heat-sealed locations, shrinking of the sheeting, non-shrinking of the nonwoven fabric layers while there is a temporary alignment of elevations of the nonwoven fabric in the third dimension and the restretching of the shrinkage resulting in a macro-opening of the preferably middle-layer sheeting at the weakened locations to form a permeable product.

The restretching of the shrinkage can be done completely or only incompletely.

Using a new composite construction and the method for producing it, the disadvantages named above may be overcome and the mechanical strength in at least one desired direction, such as crosswise to the machine running direction, may be raised manifold.

The present invention makes possible in a very simple practicable manner to create, from the two starting materials, fibers, or already preformed fibrous, porous, and water vapor and air permeable fabrics, and an impermeable sheeting, a fabric with very good breathing properties having several layers, such as a three-layer composite having very high mechanical strength both in the machine running direction and transversely to this machine running direction.

In spite of the use of impervious sheeting, the application of the present invention has led to success in forming a fabric with very good breathing and textile properties, which profits from the advantages of tensile strength reinforcement by the sheeting but does not have the disadvantages of textile property deterioration and imperviousness because of the sheeting, and even if the sheeting is not microporous, having a monolithic structure.

In one preferred specific embodiment, the three-layer fibrous composite is made of a fiber layer 1 having a surface 1a, a second fiber layer 2 having a surface 2a lying opposite surface 1a. Between fiber layers 1 and 2 continuous sheeting strips 3 are intercalated having predefined patterns, which having been first generated from sheeting—quasi in situ, e.g., as if in place—in the composite during the composite production corresponding to the method according to the present invention.

Within the framework of the present description, continuous sheeting strips or slit films are understood to mean either narrow tapes, oriented parallel to one another in a preferred direction, having in each case the same or alternatingly repeating, different spacing or continuous patterns made of sheeting strips, no polymer mass agglomerations appearing at the crossings or overlaps of the sheeting strips, in contrast to, for instance, the known extruded nettings or scrim.

The continuous sheeting strip structures may have any shapes or patterns. As a substitute, one may name sheeting strips aligned parallel to one another or twisted sheeting strips, zigzag-shaped narrow tapes aligned exactly parallel to one another or as mirror images. Netting kinds of structures are also conceivable having triangular, square or polygonal hollow places between the crosspieces, such as an hexagonal arrangement. In the latter case, honeycomb structures are mentioned which are especially found in nature too, and imitated in many technical applications. Within the framework of this description, narrow tapes are understood to mean structures having not a round but a rectangular cross section.

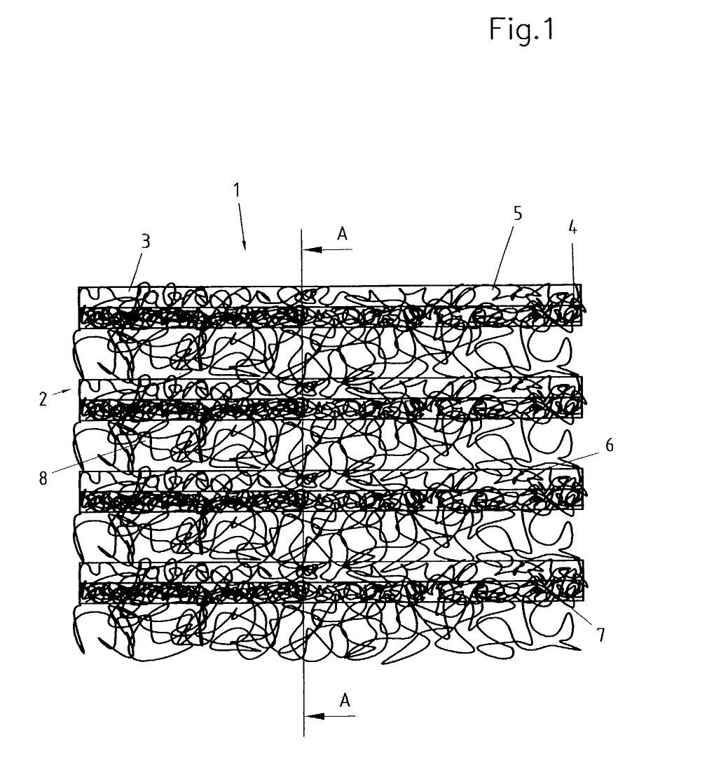

FIG. 1 shows a composite material 1 according to the present invention, in a top view. This is made of sheeting strips 2 arranged parallel to one another. Within sheeting strips 2, two different zones 3 and 4 may be recognized. Fibers 5 of the nonwoven fabric are intimately heat sealed to sheeting zones 4, whereas in the neighboring zone to zone 4, namely zone 3, the fibers are not heat sealed to the sheeting. Composite 1 is especially characterized also by the fact that surface areas 8 between sheeting strips 2 are highly pervious to gas and liquid media. Surface areas 8 are made exclusively of fibers.

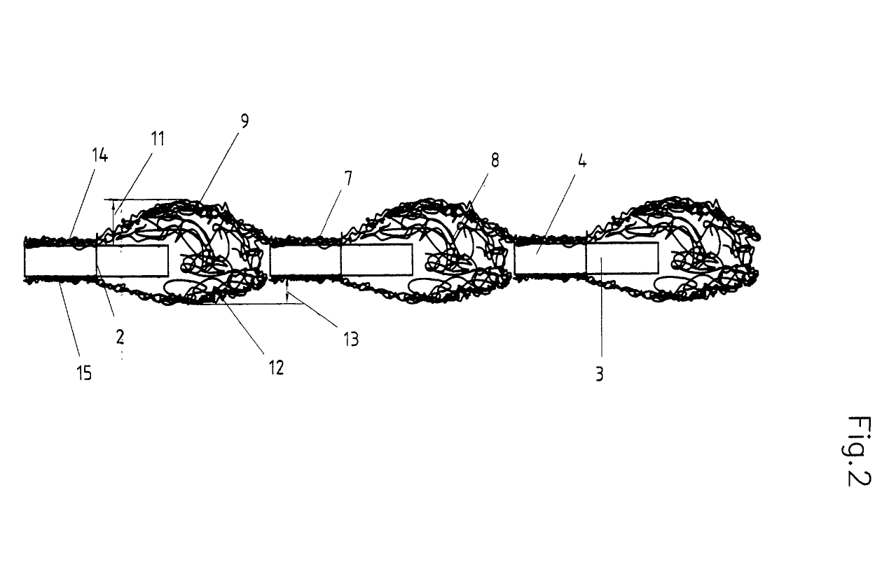

FIG. 2 is the cross section of the composite along line A-A, shown schematically. The line A-A may correspond to the machine running direction, the direction perpendicular to the machine running direction or the direction at any angle to the machine running direction.

Thus, fabric 1 has three rhythmically recurring different areas. Sheeting strip areas 4, which are heat sealed to the fibers, sheeting strip areas 3, which are not heat sealed to the fibers and areas 8 which are made in this area exclusively of unbonded fibers. Because of the intimate heat sealing of fibers 5 to sheeting areas 4, there are created, on the one hand in both directions, very high tensile strengths, and on the other hand, a great wad of fibers in areas 8. By using this construction, then, mutually completely contradictory properties may be put jointly into the laminate.

Sheeting strips 2 are shown in FIG. 2 in cross section. In the embodiment shown, the two sides B and C of sheeting strips 2 in regions 4 are heat sealed, above to larger fibers 5, and below to relatively finer fibers 10 having a low resilience capacity. The fiber sheet composed of fibers 10 of fabric 1, during calendering, is preferably made to face a smooth roller and the fiber sheet constructed from the coarse fibers is preferably made to face an embossed roller. Because of these boundary conditions, the composite forms with a completely different wad height above and below sheeting strips 2. Within the framework of the present description, wad height 11 and 13 should be understood to mean the distance between sheeting strip upper edge and position 9 having the highest elevation on the upper side B, or sheeting strip lower edge and position 12 having the highest elevation on underside C.

The heights of the two wads may be influenced particularly by the selection of the fiber's chemical composition, the fiber titer, the shape of the fiber's cross section, the fiber weight, the embossing depth, the embossing pattern, the kind of crimping (two-dimensional or spiral-shaped=helical). The choice of these parameters on side B and side C may be adapted to each application, or rather, its requirements. Hollow fibers or spirally crimped coarse fibers are preferably applied if an especially great specific volume, i.e. a high wad and a good resilience capability is demanded after compressive load in the cold or heat.

FIG. 2 shows the case of a high wadding capability on side B and a very low one on side C. At sheeting strip areas 4, both the coarse fibers of side B on sheeting strip surface 14 and fine fibers 10 at the other sheeting strip surface 15 are heat sealed intimately to the sheeting. A high wad paired with high tensile strength of wad areas 8 at heat sealed crosspieces 4, for example, simplifies hooking the hooking part of mechanical closure systems and yields high peel strength and shearing resistance. Fine fibers, as used, for instance, on side C of FIG. 2, yield relatively smooth, soft surfaces that do not scrape the skin, so that such surfaces may come into contact with the upper part of the human body without the risk that they may cause skin irritations.

Thus, using the present invention, one is in a position of incorporating completely contradictory properties in an ideal manner into one composite.

The sheeting used according to the present invention must be stretched in at least one preferred direction. The ratio of the length before to after stretching is used as the stretching ratio. For, example, if, after stretching, the sheeting has experienced a fourfold elongation above its original length, one may say that it has a stretching ratio of 5/1. To achieve as high a shrinking force as possible, the sheeting should be strongly stretched and should have a stretching ratio of at least 2/1. The upper limit of stretching is its breaking strength in the stretching direction.

It is particularly advantageous for the present invention if the stretching of the sheeting has been done in two preferred directions, i.e. in the machine running direction and crosswise to it. A high degree of stretching both in the machine running direction and also crosswise to the machine running direction influences the result of the present invention especially favorably, since then the tensile strength of the composite according to the present invention is particularly greatly increased crosswise to the machine running direction, based on the teaching that stretching, and the increase in crystallinity connected with it, clearly improves the mechanical strengths. If one can do without the particularly great increase in tensile strength, using sheeting that is stretched in only one direction is also conceivable.

As polymer raw material for the sheeting used according to the present invention, in principle, every thermoplastic plastic may be used that is extrudable and workable to sheeting. Such thermoplastics, which tend to have strong crystallization after stretching, are preferred. The nature of the thermoplastic of the stretched sheeting, for the purpose of an intensive fusion at the autogenous heat sealing locations, must preferably be the same or equal in at least a part of the fibers of the nonwoven fabric layer to be connected with it, preferably of the two nonwoven fabric layers surrounding it. If, for example, a biaxially stretched shrink sheeting made of polypropylene (“PP shrink sheeting”) is used, at least a proportion of the fibers of the nonwoven fabric layers should also be made of polypropylene (“PP”).

The sheeting may have been stretched according to known stretching methods. Blow molding through a round nozzle leads to biaxial stretching. Extrusion of the sheeting can also be done by a slit nozzle (chili roll method), which, according to known methods, is followed by one stretching in the machine running direction or transversely to the machine running direction or by only one stretching in one of the two preferred directions.

In the polymer of the sheeting, additive materials, such as dye pigments or white pigments, antimicrobial agents, antistatics or hydrophilizing agents may be included or intercalated (fused in). These agents are mentioned as being representative of many others. These sheeting additive materials may be present in the sheeting in an immobilized or a mobilized state, i.e. they may remain stored at their point of entry with or without the application of temperature, or they may migrate to the surfaces of the sheeting in order to perform their assigned effect there. The sheeting may also have been finished by application from the outside, before or after stretching. Representative of such finishing are treatment by low-pressure plasma or atmospheric plasma, vapor deposition of metals under high vacuum or coatings.

One may also use copolymers or blends for the sheeting extrudate.

For the production of a composite made of stretched PP staple fibers and PP strips in the middle layer, it is advantageous for optimum composite tensile strength if a PP sheeting is used as starting material, which has been produced according to the chill roll method and has been stretched to the greatest degree possible in the machine running direction and transversely to the machine running direction. In this case a PP sheeting is involved which has been stretched in the machine running direction in the ratio of 1:5, and transversely to the machine running direction of 1:9 to 1:10. Such sheetings are highly transparent and have a melting point of ca. 150° to 155° C., and thus the same as that of the PP staple fibers. The breaking strengths of such PP sheetings are approximately twice as great transversely to the machine running direction as in the machine running direction. Such sheetings are also quite especially suitable for the purpose of achieving particularly great crosswise tensile strength increases. If PP nonwoven material layers are used as fiber layers, it may then be advantageous, for the purpose of the optimum composite tensile strength, to conduct only one partial stretching in the machine running direction, and a partial to full stretching crosswise to the machine running direction.

The sheeting is preferably a stretched monolithic sheeting. However, it can also be made of sheeting stretched monoaxially or biaxially crosswise to the machine running direction having a mineral matter filling, such as chalk coated with an adhesive agent for the purpose of generating a microporous structure, although such sheeting is not particularly advantageous for the method, since the sheeting is weakened by the microporosity and the permeability to water vapor is created by the macro-pores created in the ready composite material.

The two fiber layers as starting material for the three-layer nonwoven fabric/slit film/nonwoven fabric-composite construction according to the present invention, shown in FIGS. 1 and 2, may be present as loose, completely unattached fiber sheets formed by using dry nonwoven fabric lay-up methods, between which the sheeting is introduced as the third starting material before the calender bonding/laminating. The fibers may be present as cut staple fibers or as continuous filaments. They may be crimped 2-dimensionally and/or 3-dimensionally (e.g., helical or spiral-shaped). Even blends of crimped and non-crimped fibers are conceivable, and likewise blending of continuous fibers with short-cut or staple fibers (so-called coform products). The two fiber layers are usually stretched either mechanically or aerodynamically stretched or drawn. However, it is also conceivable to admix to the stretched fibers also fibers either of the same or different polymer construction which have been only partially stretched or not at all.

All known nonwoven fabric web laying methods are suitable for laying up fibers on an endless belt or support medium. In the case of a nonwoven fabric laid up according to the Fourdrinier Principle (wet laid nonwoven), however, before calendering to form the composite, the water has to be removed by drying. However, since the water has a plasticizing effect on the fiber or at least one of the fiber components in the case of a blend, a low residual moisture may remain in the fiber sheet.

One of the two fiber layers or both may already be prebonded before calendering, under heat and pressure, by known methods of spunbonding, the bonding being able to be over the partial surface or full surface.

However, for the sake of simplicity and cost, at least in the case of staple fiber layers, prebonding may be dispensed with.

In principle, the entire spectrum of fiber diameters and fiber cross sections may be used. Fiber titer blends are also possible. Limitations occur only to the extent that, with increasing titer, increasing fiber stiffness increasingly hinders the shrinking. Thus, if in the composite material one wishes to have especially high proportions of area without sheeting strips or sheeting fragments, i.e. especially high air or fluid permeabilities, and a high degree of textile properties are desired, very coarse titers are not an advantage.

And so the choice of titers is codetermined by the above considerations, and naturally by the demands of the most different application.

The titers of the fibers used in the fiber layers are in the range of ca. 0.05 to ca. 50 dtex. Fibers below ca. 0.5 dtex are preferably made by mechanical or hydrodynamic splitting of bicomponent fibers of the most different cross sections.

It is familiar to one skilled in the art that, for the purpose of good composite strength, blending components of the fiber mixture are made of such thermoplastics which have a chemically equal, or at least similar structure, and have equal or at least very similar softening or melting points. Demands on the composite strength are different, depending on the application of the composite construction according to the present invention.

The fibers may be revived hydrophobically, may already be hydrophobic when in the plant, or may also be hydrophilized or developed hydrophilic, going back to the polymer. The fibers may be fully synthetic or semisynthetic. The water absorptive capacity and retention capacity may be raised to the level demanded by the application by the admixture of cellulose fibers, such as viscose staple fibre, lyocell, cotton or cellulose. The fiber mixture may also include proportionally super-absorbing particles in the form of fibers or powder.

The fibers of the nonwoven fabric used according to the present invention may have been laid up in the machine running direction, crosswise to the machine running direction or in a so-called random laid layer, i.e. laid up anisotropically. The fiber sheets laid up plaited down crosswise to the machine running direction may additionally have been reoriented for the purpose of speed increase in the machine running direction up to various degrees, using so-called accelerators. The random laying of the fibers may have been performed aerodynamically.

The fiber orientation is to a great extent determined by the requirements for mechanical strength in the machine running direction, and crosswise to it (from here on also denoted as “cd”). It has also been shown in the method according to the present invention that comparatively the highest shrinkage values are achieved when having the fiber orientation crosswise (i.e. at a 90° angle) to the desired shrinkage direction. If, for example, in a composite fiber layer/nonwoven fabric strip made of sheeting/fiber layer, in which an optimally stretched PP shrink sheeting (11:5 in md and 1:9 in cd) was inserted as the initial middle layer, the crosswise shrinkage is to be largely eliminated and, on the other hand, the longwise shrinkage (in the machine running direction) is to be promoted, laying up the fiber sheet crosswise to the machine running direction is of advantage.

The present invention is distinguished from all other known binding methods in that the longwise-crosswise ratio of the breaking strength forces in the composite material may be greatly altered compared to that of the pure nonwoven fabric components.

If, for example, a nonwoven fabric, whose fibers were laid up in the machine running direction, and which subsequently has been bonded by a known bonding method, and has a breaking strength, in the machine running direction, of 50 N/5 cm of strip width and 10 N/5 cm crosswise to the machine running direction, and is additionally bonded by a further aftertreatment, such as printing, full bath impregnation or foam impregnation, it is true that the breaking strength is increased in both preferred directions, but the longwise/crosswise ratio of the breaking strength remains unchanged at 5:1 (50 to 10 N/5 cm strip width).

However, the composite fabric according to the present invention, having good breathing properties, is distinguished in that, because of the method, according to the present invention, of the formation of a permeable sheeting structure from an originally monolithic (impervious) sheeting, in combination with the nonwoven fabric, brings about an additive increase in strength corresponding to the absolute amount of the sheeting. If, for example, a PP sheeting has been stretched by an air-lay system, it will have an equal stretching ratio in the machine running direction and crosswise to it, and thus it will also have equal strengths in these two directions. If the breaking strength of the PP sheeting is, for instance, 50 N/5 cm in both directions, the composite has breaking strengths in the machine running direction of 50+50=100 N/5 cm, and in the crosswise direction 10+50=60 N/5 cm. The ratio of the breaking strengths longwise/crosswise has changed, compared to that of the nonwoven fabric, from 5:1 to 10:6=1.67:1, that is, clearly in favor of the crosswise direction.

The composite material may be the same or not the same, below or above the sheeting or the slit film or sheeting netting used according to the method of the present invention, with respect to the fiber mass per unit area, fiber composition, fiber titer or titer mixture. Therefore, according to this, symmetrical or asymmetrical structures are created in the development. Within the framework of this description, like or unlike structures are understood by this as mirror images across the sheeting or the slit film or the sheeting netting. In view of the fact that usually a calender roll pair is made up of a smooth and an engraved roller, in spite of the same construction, an optically seeming asymmetry may be created on both sides of the sheeting having higher elevations on the engraved roller side and lower or no elevations at all on the smooth roller side.

A preferred variant of the method according to the present invention is based on the fact that, in a three-layer composite made up of two fiber layers on the outside and one sheeting used as middle layer, the sheeting shrinks either at the point of leaving the calender nips or after subsequent additional heat application, causing the formation of undulations or other types of elevation perpendicularly to the sheeting plane. In this context, the heat sealed locations at the edges of the three-dimensional composite are already weakened in such a manner that, because of the tensile stress in the machine running direction, crosswise to it, or in both directions, an elongation of the fabric takes place along with the disappearance of the three-dimensional structure. Because of the stretching or drawing of the fabric up until the disappearance of the undulations or elevations, the sheeting tears at the weakened locations while forming perforated structures or tapes, the shape of the perforations or sheeting openings being largely predetermined by the engraving used on the calender roll.

The stretching or drawing may be done directly after the composite leaves, still having the sheeting intact but weakened at the contours, or it may be done in a separate working step. The drawing or stretching of the composite in the machine running direction may be carried out using means known per se by appropriate speed differences in the nips of two roller pairs, for the purpose of making the drawing uniform and the weight per area constant over the entire width of the goods between the braking roller pair and the drawing roller pair additional rollers at higher speeds being situated, mostly not self-propelled, which are wound around by the composite to be stretched. In U.S. Pat. No. 6,051,177 and 5,244,482 such drawing machines are described. Drawing takes place preferably at temperatures clearly below the softening point of the sheeting or below the glass transition temperature of the sheeting and quite especially preferred in the cold (at room temperature).

Drawing crosswise to the machine running direction is done preferably either in a tenter frame or in meshing grooved rollers.

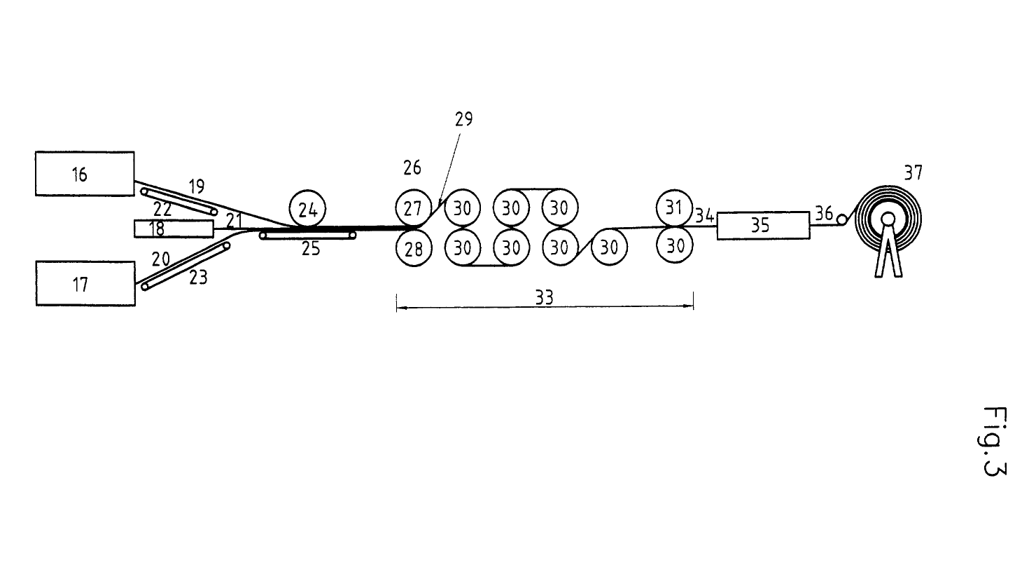

FIG. 3 shows schematically a manufacturing line for making the composite according to the present invention.

From nonwoven fabric forming device 16, a first fiber sheet 19 is laid up on upper support belt (lath belt) 22 and from nonwoven fabric forming device 17 a second fiber sheet 20 is laid up on lower support belt 23. Between first fiber sheet 19 and second fiber sheet 20, coming from the side, i.e. at a 90° angle to the machine running direction, a sheeting 21 is redirected into the machine running direction from sheeting supply device 18 via a 45° sword edge (not shown in FIG. 3), so that drawn sheeting 21 forms the middle layer of the three-layer material formed from first fiber sheet 10, second fiber sheet 20 and the sheeting. This three-layer composite is transported in the machine running direction by support belt 25 and, for the purpose of better transportation, is lightly pressed together, using a tension roller 24. This also simplifies introducing the 3-layer laminate into the press gap of the calender made up of the two rollers 27 and 28. Of the two calender rollers 27 and 28, one is furnished with an engraving and the other possesses a smooth or slightly roughened surface. The three-layer laminate composited in the calender press gap is guided over several rollers 30 provided with a smooth surface, these rollers either not being driven themselves, or, in each case in which they do have their own drive, the rotational speed in the machine running direction is ever more increased from one roller to the next. Finally the goods 34 pass the press gap of the press made up of the two drawing rollers 31 and 32 which are self-driven. The rotational speed of rollers 31 and 32, or the transportational speed of the goods 34 in the press gap is greater than that of the as yet unstretched composite material 29 as it passes roller pair 27 and 28. The ratio of the rotational speed of rollers 31 and 32 to 27 and 28 determines the drawing or stretching ratio. The drawing or stretching in longwise drawing machine 33 is carried out in a manner or to the extent that essentially no loss in width is connected with it (i.e. no neck-in). The drawing ratio without loss in width is determined by the shrinkage amount which drawn sheeting 21 undergoes in the machine running direction during the passage through the calender.

At the corners of the heat sealing lines a weakening appears when the edges of the engraving lines are not rounded off. The weakening of the sheeting is an essential presupposition for the functioning of the method. During stretching stress, the heat sealed locations tear open and yield areas having good breathing properties which are not covered by sheeting. Thus, the shape of the line-shaped openings and therefore also the sheeting fragment shapes remaining after stretching as middle layer of the composite material are predefined by the design of the engraved roller and the amount of shrinking of the sheeting. By the stretching in the running direction, for instance, the undulations of the two nonwoven fabric layers are drawn flat during bursting open at the weakened edges of the heat sealed locations, while the three-dimensional structure is lost.

Composite material 34 may be wound up right after the drawing operation. But it may also be additionally stretched crosswise in a tension frame with clips, in order to generate torn sheeting locations also in the crosswise direction. Because of crosswise stretching device 35, composite material 34 experiences a corresponding increase in area, and is thereby carried over into the wider composite material 36. Finally, the goods are rolled up to a master roll 32. When sheets are used that are stretched monoaxially in the machine running direction, which, therefore, shrink exclusively in this direction, a crosswise stretching (without longitudinal shrinkage) is generally less preferred.

Besides, it should be noted that the method prefers the use of biaxially stretched fibers also because much greater crosswise tensile strengths come about or rather, the contribution to crosswise tensile strength turns out many times higher than in the case of a sheet not stretched crosswise to the machine running direction.

The sheet shrinkage in the machine running direction is usually in the range of 5% to 60%, and the lengthwise stretching ratio is accordingly in the range of 1:1.05 to 1:2.50, this referring to the shrunken goods.

For stretching in the range of 1/1.05 to ca. 1/1.30 one may do without rollers 30 between stretching locations 27/28 and 31/32. For very high stretching ratios of more than ca. 1 /2.0 it may be advisable to work with more than two press roller nips. In principle, such stretching systems for producing of monoaxially and/or biaxially stretched sheets are known. They only have to be adapted to the clearly lower stretching ratios for the nonwoven fiber/sheet/nonwoven fiber composite materials according to the present invention.

FIG. 3 shows the case of an in-line production all the way to the final material. Such a line is available for producing open sheet surfaces in the composite material of ca. 5% to ca. 40%. In the case of open surfaces of more than ca. 40%, it may be advisable to carry out the production of the composite fiber/sheet/fiber using heat and pressure up to the step where the sheet has not shrunk yet in a separate method step, to shrink in a second step, and, in a third step to pull out again the shrinkage or the undulation or elevation with a resulting opening of the sheet. In this context, steps two and three can be done in-line again.

In the case of great shrinkage and the production of correspondingly large open surfaces and the carrying out of the process in two or three steps, the first step of making the composite material may be carried out with still intact, unshrunken sheet, instead of with heat and pressure, also by using ultrasound sealing. In a separate working process one can then do the shrinking by the effect of heat and carry out the production of the sheet openings in the middle of the composite material by applying tension in one or both preferred directions.

However, the preferred method is the in-line method shown in FIG. 3.

The shape of the sheet openings and the percentage degree of opening are predetermined by the calender engraving, the degree of shrinkage and the stretching ratio in the machine running direction. The prerequisite for the successful production of the sheet openings is the purposeful deterioration or weakening of the composite at least one of the outer edges of the heat sealing areas.

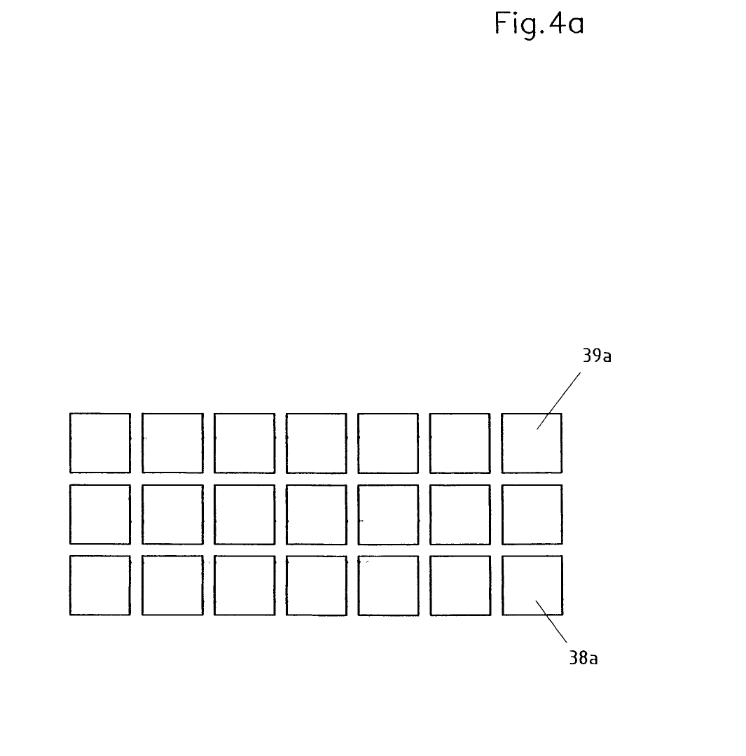

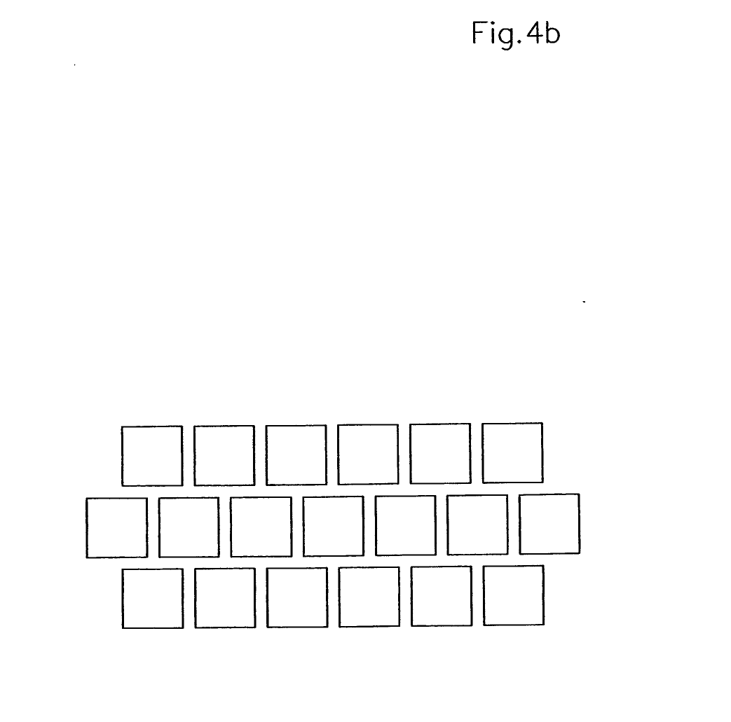

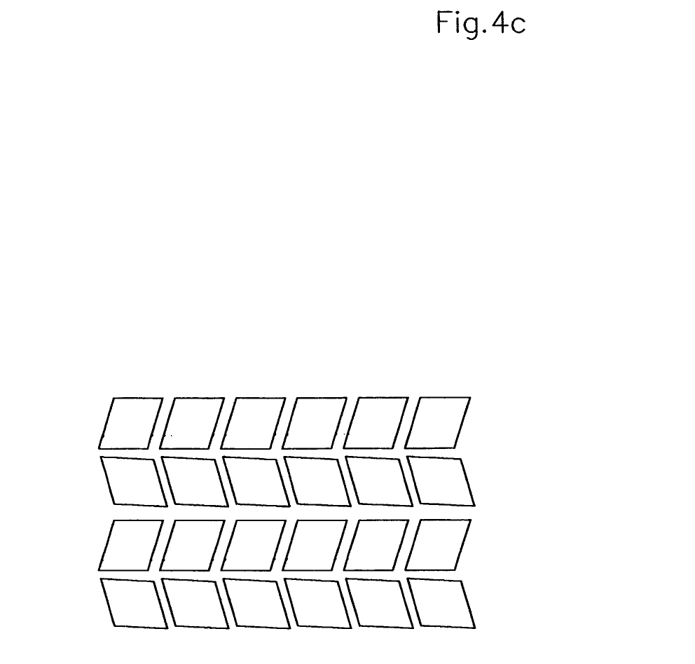

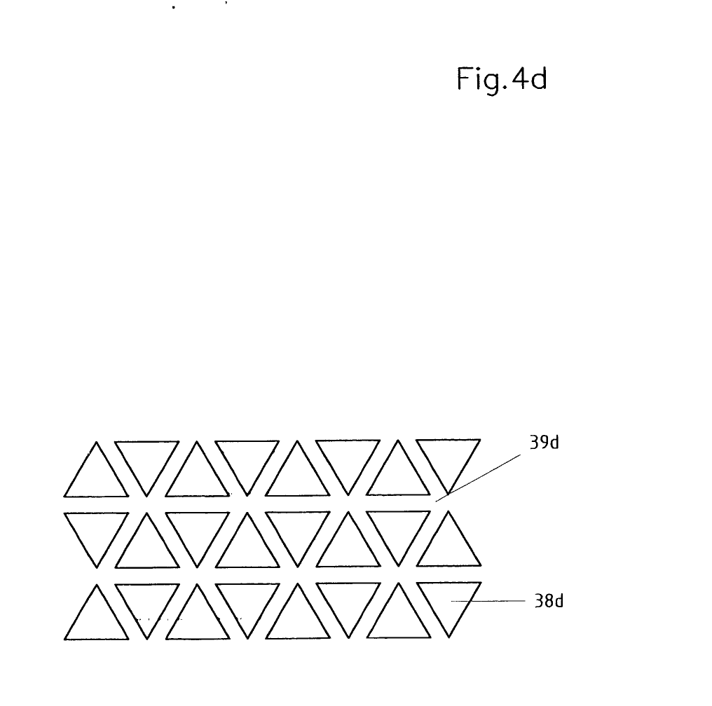

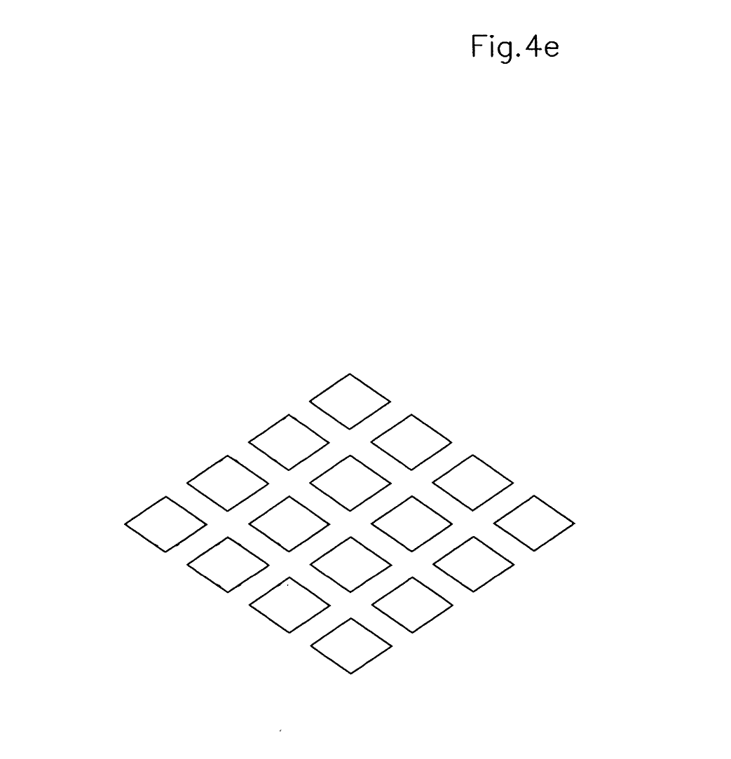

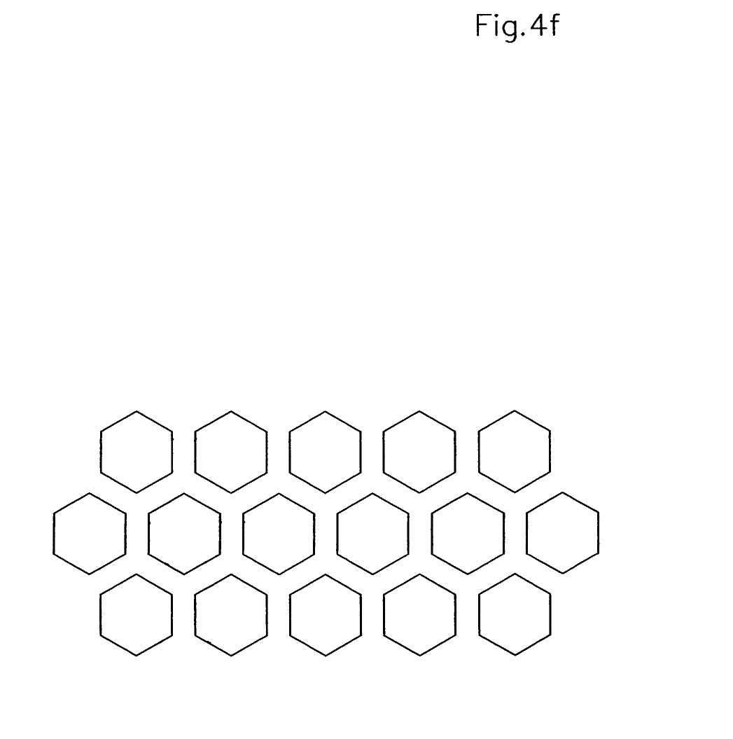

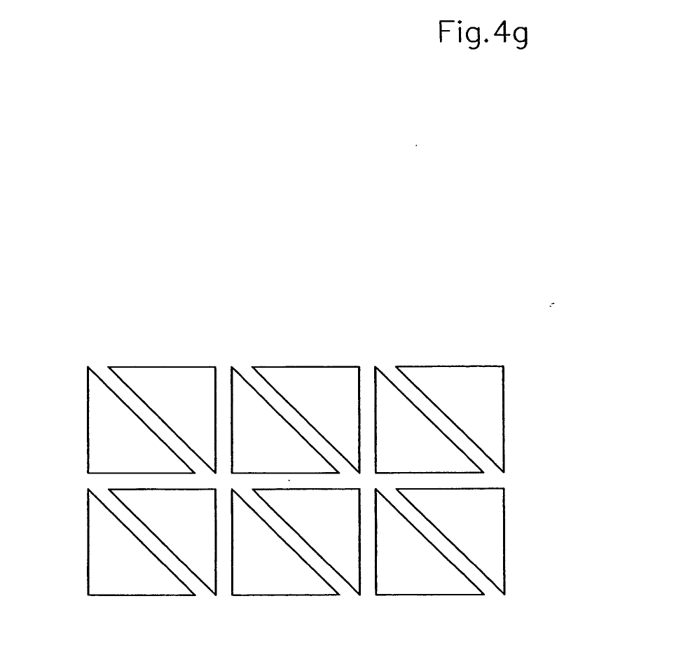

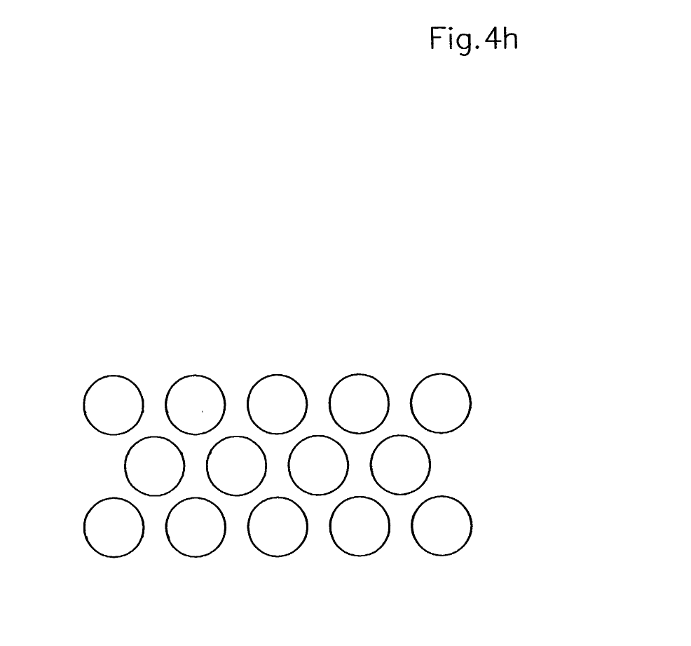

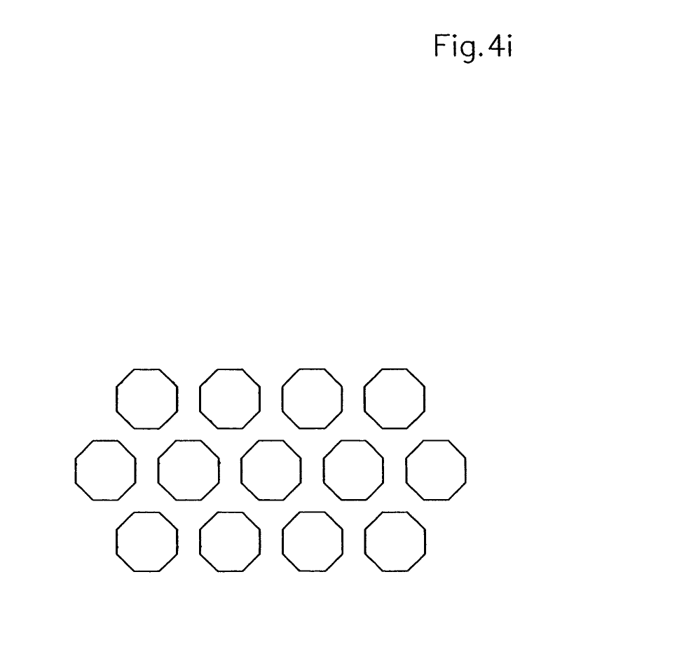

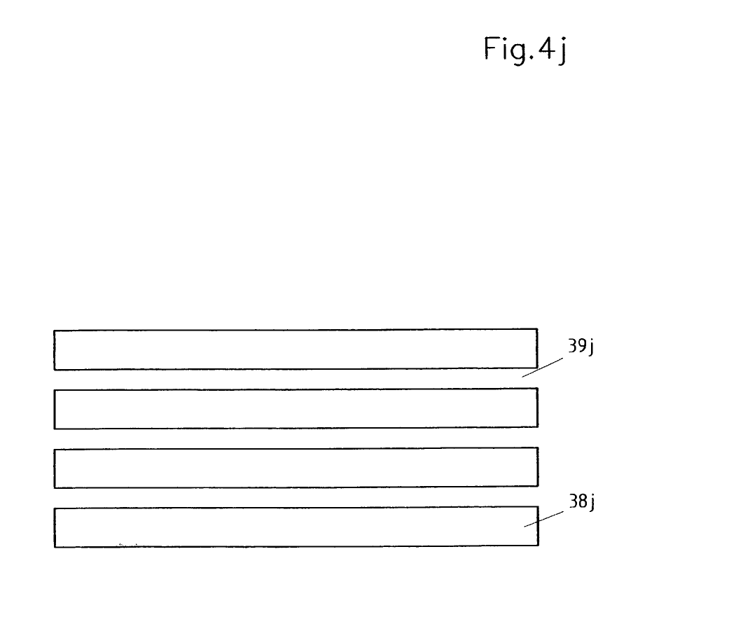

In FIGS. 4a to 4j, different engravings are reproduced in a top view. The raised continuous areas of the engraved roller are marked in two examples by 38a, 38d and 38j.

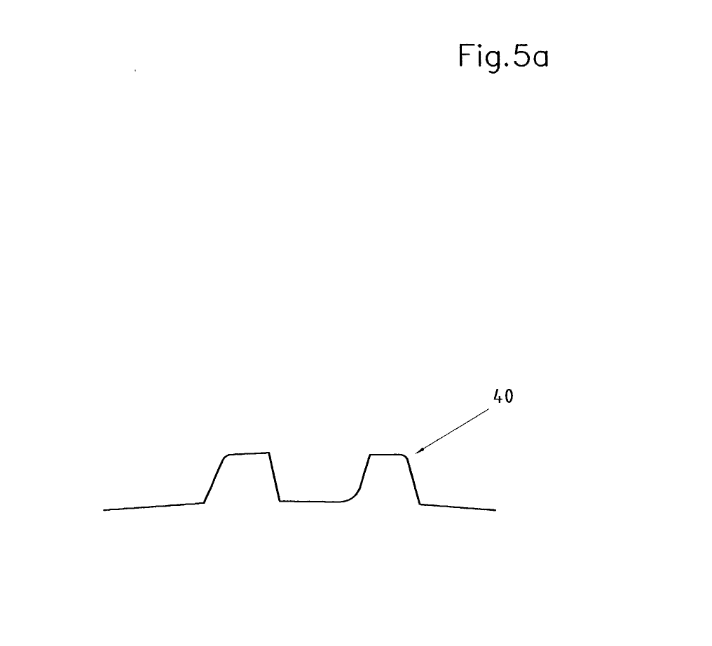

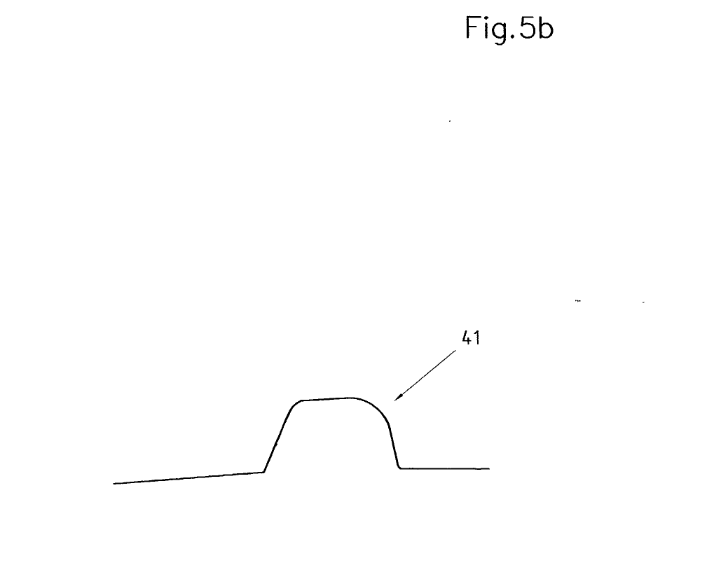

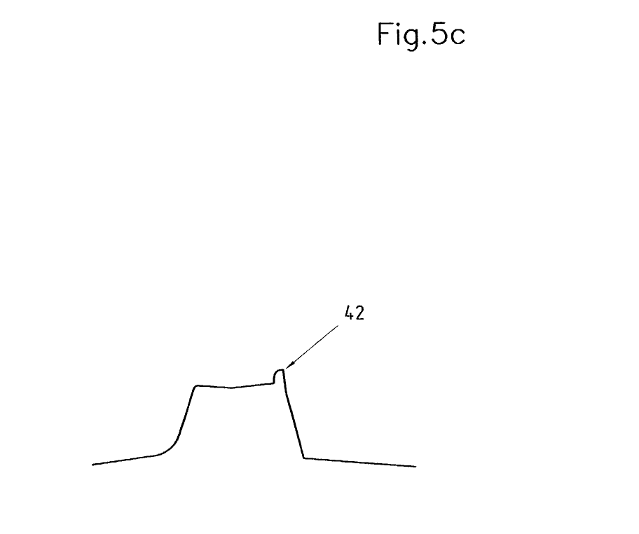

FIG. 5a shows a section of the surface of an engraved calender roll in cross section. Edges 40 of the elevations in the engravings are designed as sharp edges. This is important for the method according to the present invention so that one may achieve a weakening of the heat sealing at this point for the purpose of the later opening of the sheet after shrinkage. Exclusively rounded corners 41 as shown in FIG. 5b are not advantageous to the method.

Crater-shaped elevations 42, as shown in FIG. 5b, are indeed advantageous to the method, but are not absolutely necessary.

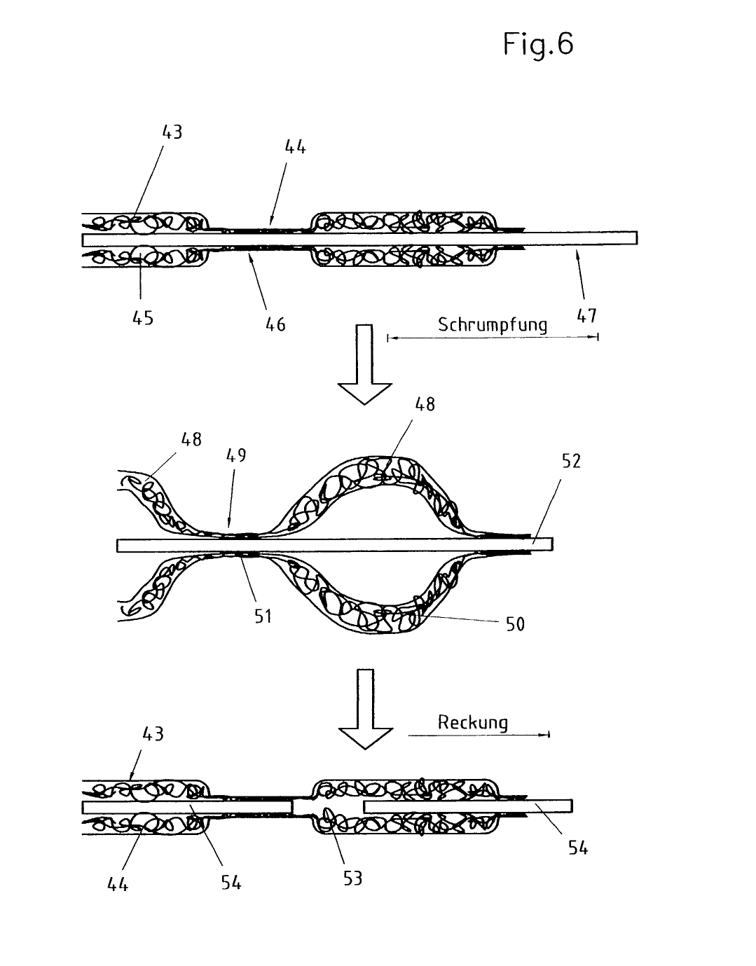

FIG. 6 shows schematically the individual steps of the formation of regular sheet openings in the middle layer of the three-layer composite material.

Fiber sheets 43 and 45 are compressed at the upper locations 44 and the lower locations 46, and heat-sealed to sheet 47. Shrinkage of the sheet has not yet taken place.

In the second part of FIG. 6, the sheet is shrunk along the direction along its cross section, with a corresponding shrinking of the length, and is thereby brought into condition 52. Thereby both the size of the heat sealed location and the distance between the reduced heat sealed locations 49 above and 51 below are shortened, and fiber sheets 43 and 45 are converted into an undulating state 48 above and 50 below. At the edges of heat seals 49 and 51 the shrunken sheet has been weakened. After extending or stretching the shrunken goods in one or two preferred directions (FIG. 6 shows only one), the sheet tears open at the weakened location and forms openings 53, whose shape and area depend on the engraving of the roller and the amount of shrinkage. After stretching, fiber sheets 43 and 44 are almost transformed back again to the initial state when the whole amount of shrinking is pulled out again, with the exception, however, that the bonding areas remain in the shortened state 49 and 51.

For a stretching below the total shrinking, naturally undulations, elevations or other alignments in the third dimension will remain which, however turn out smaller than in the undulating fiber sheets 48 and 50. In the case of an uninterrupted linear heat sealed area having an orientation crosswise to the machine running direction, and shrinkage in both directions but stretching only in the machine running direction, an additional microcrepe effect is produced, which additionally contributes to an increase in the textile properties of the goods.

The composite material according to the present invention stands out by an increased crosswise tensile strength at simultaneously good longwise tensile strength, and may especially be used in applications which require high mechanical tearing stress in both directions and additional textile properties and a high breathing activity. Such applications are operating room coats, textile outer materials for one-time use and belts. By the use of sheets coated with metal, such as aluminum, copper or silver, one may introduce conductivity or antimicrobial properties in the new nonwoven fabric composite, in addition to the increase in tensile strength. These additional properties may be used in hygiene applications and medical applications, such as for wrapping or covering diapers or female hygiene products, or absorbing films or layers on or in absorbent products.

These applications are also the subject matter of the present invention.

The following examples describe the present invention without limiting it.

### EXAMPLE 1

Two staple fiber sheets a and b were laid up on a conveyor. Staple fiber sheet a was made of 100% crimped bicomponent fibre cut to 60 mm, having a titer of 6.7 dtex, and designed with a core/sheath configuration, and it had a mass/unit area of 28 g/m² and was laid up as a random web in the machine running direction. Staple fiber sheet b was made of 100% polypropylene fiber having a titer of 2.8 dtex, a staple length of 60 mm and a sheet weight of 10 g/m². In contrast to sheet a, it was laid up in the machine running direction. Between the two fiber sheets there was introduced, crosswise to the machine running direction, a 17 μm thick transparent PP foil, made by the blown film process and stretched biaxially, and it was deflected via a 45° deflecting sword into the machine running direction and positioned between the two fiber sheets a and b.

After a prior compression, the composite of these three loose layers, staple fiber sheet a, PP sheet and staple fiber sheet b, was compressed in the nip between two smooth, unheated steel rollers. This simplified feeding it to a calender, whose principal elements were a smooth and an engraved steel roller, both heated. The surface design of the engraved steel roll was composed of lines oriented parallel to one another and almost crosswise to the machine running direction, which were elevated 0.8 mm from the roll (surface) base and had a distance from one another of 4 mm. The distance between a line edge and to the next of the following lines was 3 mm, and the width of the lines or crosspieces accordingly was 1 mm. This yielded a heat sealed area of 25%, with respect to the extent of the overall area of the goods. In order to ensure a sufficiently quiet run during thermal calendering (no so-called chattering), the lines were not oriented exactly at an angle of 90° to the machine running direction, but at an angle deviating from this by about 0.80. In addition, the calender roll was provided with so-called support edges, for the added improvement of silent running.

The three layers were guided through the calender press nip at a speed of 3 m/min and thereby heat sealed to one another. The temperature of the two calender rolls was 145° C. in each case, and the calender line force was 55 N/mm. Fiber sheet layer a having the coarse titer 6.7 dtex fibers was facing toward the engraved roll. After leaving the roller press nip, the goods looped around on about one quarter of the smoothing roll surface before it was then guided on. Because of the relatively long retention time achieved thereby, and the temperature contact, the sheeting in the middle of the composite material experienced a surface shrinkage in both directions. By diversion over a bent roll (a so-called crooked dog), a portion of the shrinkage crosswise to the machine running direction was pulled out again.

By keeping to the same speed before and after the calender press nip, a great tensile stress was exercised after the calender press nip, which, in the still warm condition of the goods on the calender smoothing roll led to a tearing open of the centrally positioned sheeting into foil-type strips. Thereby a composite structure is generated having three different constantly repeating zones.

1. A linear, dull looking heat seal zone having a width of ca. 0.9 mm.

2. A linear zone in which the two nonwoven fabric layers were not heat sealed to the sheeting, having a width of ca. 1.4 mm. These foil-type strip areas had kept their sheen.

3. A linear zone including only the two nonwoven fabric layers, and had a width of ca. 1.6 mm and was thus highly permeable.

The permeable zone free of the sheeting thus amounted to 1.5/3.9=41.0% in relation to the total area of the composite material. The side of fiber sheet a formed weak undulations, whereas fine fiber sheet b was smoothed out flat because of its contact with the smoothing roll.

The original total of materials used, fiber sheets and sheeting per m² before calendering was 28+15+8=51 g/m² (without shrinkage).

By comparison, the finished material weight after application of the shrinkage/stretching conditions was 58 g/m². The decrease in heat seal line width from 1 mm to 0.90 mm resulted in an area loss of about 0.1/4.0×100=2.5%. Because of the shrinkage that was not completely pulled out crosswise to the machine running direction via bent rolls, in the crosswise direction there remained a shortening of about 9.8%. This remaining crosswise shrinkage showed itself as a microcreping in the machine running direction and gave to this exemplary embodiment great textile properties and draping capability in both directions.

The variant of the present invention described in Example 1 could, for example, be used as a loop component of mechanical closure systems, particularly when great crosswise tensile strengths are demanded. The loop side is the coarse fiber sheet side a.

### EXAMPLE COMPARISON TO 1

The two staple fiber sheets were specified, but leaving out the 17 micrometer PP shrunken sheet, under the same condition as in example 1. In so doing, a 2-layer nonwoven fabric composite material was produced without any shrinkage, having an area weight of 38 g/m².

Table a reproduces the most important test results of Example 1 and the example comparison to 1.

TABLE a

| | | Thick- | HZK* | HZK* | Modulus at 10% | | Extension | | | Flexural Strength |
|---|---|---|---|---|---|---|---|---|---|---|
| Ex- | Weight | ness | N/5 cm | N/5 cm | Extension | | at HZK % | | Drape- | (Cantilever Test) |
| ample | g/m² | mm | Longwise | Crosswise | Longwise | Crosswise | Longwise | Crosswise | ability | Crosswise |
| 1 | 58.8 | 0.52 | 99.6 | 56.1 | 57.6 | 21.3 | 31.1 | 74.2 | 35 | 5.5 |
| V1 | 38.4 | 0.44 | 46.9 | 7.8 | 29.1 | 5.9 | 21.7 | 26.8 | 17 | 6.5 |

The draping capability was determined according to DIN 54 306. To do this, in each case the stamped out circular test piece was laid with the flatter side down on the measuring plate. The flatter side of the composite material is that side which is in contact with the smoothing roll during calendering.

The bending resistance was determined by the so-called cantilever method, according to DIN 53 362. The strips for the measurement were in each case stamped out only crosswise to the machine running direction and were clamped into the measuring apparatus in such a way that the smooth side of the composite material was always directed downwards.

### EXAMPLE 2

Compared to Example 1, it is true that for Example 2 the same testing arrangement was selected, however, a 15 μm PP shrinkage sheet, stretched axially by the blown film process, was used, and random fiber sheet a of Example 1 was used by a 28 g/m² lengthwise fiber sheet having a fiber composition of 70% polyester fiber (PET) having a titer of 6.7 dtex and a staple length of 60 mm as well as 30% core/sheath bicomponent fiber of polyethyleneterephthalate and polypropylene having a titer of 3.3 dtex and a staple length of 51 mm. The other side of the sheeting was backed with a 10 g/g/m² staple fiber sheet having a fiber composition of 70% polyester fiber (PET), a titer of 1.7 dtex and a staple length of 38 mm, as well as 30% core/sheath bicomponent fiber having a titer of 3.3 dtex and a staple length of 51 mm.

The smoothing roll temperature was set to a temperature of 148° C. and the engraved roll temperature was set to 151° C. The line force in the press nip was again 55 N/mm. The speed was 4.5 m/min. Under the conditions as described in Example 1 approximately the same shrinkage and linear sheet strip formation were achieved in the middle of the composite material.

### EXAMPLE COMPARISON TO 2

As in the example comparison to 1, here too the 15 μm PP sheet was omitted, and a “linear seal”-bonded composite was produced under the calendering conditions, as described in Example 2.

The test results of Example 2 and the comparison example to 2 are reproduced in following table b.

TABLE b

| | | Thick- | HZK* | HZK* | Modulus at 10% | | Extension | | | Flexural Strength |
|---|---|---|---|---|---|---|---|---|---|---|
| Ex- | Weight | ness | N/5 cm | N/5 cm | Extension | | at HZK % | | Drape- | (Cantilever Test) |
| ample | g/m² | mm | Longwise | Crosswise | Longwise | Crosswise | Longwise | Crosswise | ability | Crosswise |
| 2 | 59.9 | | 97.1 | 47.1 | 30.5 | 12.1 | 49.9 | 131.5 | 46 | 4.0 |
| V2 | 38.2 | | 43.6 | 7.6 | 29.1 | 5.9 | 22.3 | 27.3 | 19 | 6.0 |

HZ = Breaking Force

In the results of Table b one sees, even more clearly than in Table a, the increase of the breaking force crosswise by more than six-fold combined with an extremely big increase in extension crosswise to ca. five-fold, which may be ascribed to the relatively high elongation potential of the crosswise slit film formed.

### EXAMPLE 3

Using the same equipment as in Examples 1 and 2, a 25 g/m² random fiber sheet made of 100% polypropylene staple fibers having a titer of 1.7 and a staple fiber length of 40 mm in the machine running direction, and an 8 g/g/m² lengthwise fiber sheet made of 100% polypropylene fibers having a titer of 1.7 dtex, a staple length of 40 mm were laid up on conveyors, and again a PP sheet was positioned between the two fiber sheets in a manner as described in Example 1. The polypropylene sheet used in Example 3 differed from both the sheets used Example 1 and 2 in that it was produced according to the chill roll method (that is, pouring a sheet onto a roll from a sheeting die) and was stretched deliberately extremely hard with a stretching ratio of 1:5 in the machine running direction (over several stretching zones and rolls) and crosswise to the machine running direction to nine-fold of the original width (crosswise stretching ratio 1:9). The thickness of this polypropylene sheet stretched extremely hard biaxially was only 12 μm. The melting point of the sheeting was in the range of 160° to 166° C., and its breaking strength lengthwise was 83 N/5 cm and crosswise was 150 N/5 cm.

The temperatures of both calender rolls were 155° C. and the line pressure in the calender press nip was again 55 N/mm.

Just as in Example 1, by applying a tensile stress, linear foil-type strip was achieved in the middle of the composite material. After release, a shortening in the length of about 2.6% remained in the goods, and so did a loss in width by shrinkage of 15.4%, which was clearly higher in comparison to Example 1. The great loss in width showed up as a strong microcrepe effect over the whole width, i.e. along the foil-type strip. Thus the entire area loss amounted to 17.6%.

In Example 3 a composite material was created which was optically almost identical to that of Example 1, but differed from that of Example 1 particularly on account of its higher crosswise tensile strength and a somewhat harder hand. The great increase in the breaking force in the crosswise direction as compared to Example 1 could be ascribed exclusively to the high degree of stretching of the PP sheet crosswise to the machine running direction (stretching extent 1:9).

### EXAMPLE COMPARISON TO 3

As was described in example comparisons to 1 and 2, the sheeting was left out, i.e. under the conditions otherwise described in Example 3, a two-layer nonwoven fabric was produced having a stronger lengthwise orientation.

The test data of Example 3 and of the example comparison to 3 are summarized in Table c:

TABLE c

| | | Thick- | HZK* | HZK* | Modulus at 10% | | Extension | | | Flexural Strength |
|---|---|---|---|---|---|---|---|---|---|---|
| Ex- | Weight | ness | N/5 cm | N/5 cm | Extension | | at HZK % | | Drape- | (Cantilever Test) |
| ample | g/m² | mm | Longwise | Crosswise | Longwise | Crosswise | Longwise | Crosswise | ability | Crosswise |
| 3 | 53.2 | 0.48 | 123.3 | 158.2 | 66.9 | 99.8 | 35.2 | 102.2 | 39 | 4.0 |
| V3 | 31.2 | 0.21 | 34.3 | 6.8 | 23.6 | 4.9 | 19.1 | 24.4 | 20 | 6.5 |

HZK=Breaking Force

It may be seen very clearly in Table c how greatly especially the breaking strength crosswise through the construction according to the present invention, and the method used for producing it, may be raised. The longwise/crosswise ratio of 5:1 in the comparison sample could be completely changed in Example 3 to 1/1.28; that means that from a strongly longwise oriented nonwoven fabric a composite material could even be created having higher crosswise than longwise tensile strength.

What is claimed is:

1. A composite material comprising at least one nonwoven fabric and a reinforcing material, thermally connected to it, situated in the form of regularly recurring patterns, which is derived from sheeting made of thermoplastic material.

2. The composite material according to claim 1, wherein it has at least three layers in the sequence nonwoven fabric/reinforcing material/nonwoven fabric.

3. The composite material according to claim 1, wherein the nonwoven fabric is a staple fiber nonwoven fabric.

4. The composite material according to claim 1, wherein the sheeting made of thermoplastic material is a uniaxially or biaxially stretched sheeting, which is preferably made of polyolefins.

5. The composite material according to claim 4, wherein the sheeting is made of polyethylene or especially of polypropylene.

6. The composite material according to claim 1, wherein the nonwoven fabric is connected to the sheeting by heat sealing to at least one surface of the nonwoven fabric in the form of regularly recurring patterns, and at these locations on the surface of the nonwoven fabric, the sheeting has remained intact, and at other locations on the surface of the nonwoven fabric the sheeting is no longer present as a result of tearing of the sheeting.

7. The composite material according to claim 6, wherein the regularly recurring pattern has the shape of lines or bars running regularly perpendicular to, and/or in the machine running direction.

8. The composite material according to claim 6, wherein the regularly recurring pattern has the shape of lines running regularly in the form of hexagons.

9. The composite material according to claim 6, wherein it has three different rhythmically recurring regions, which are the foil-type strip regions (4) that are heat sealed to the fibers of the nonwoven fabric, the foil-type strip regions (3) that are not heat sealed to the fibers of the nonwoven fabric, and the regions (8) that in this region are made up exclusively of unbonded fibers.

10. The composite material according to claim 2, wherein the one nonwoven fabric is made up of larger fibers, which have a very good resilience capability, and the second nonwoven fabric is made up of finer fibers having a low resilience capability.

11. The nonwoven fabric according to claim 1, wherein this has a mass per unit area of 15 through 250 g/m².

12. The composite material according to claim 1, wherein this essentially has a planar structure and essentially has no elevations or depressions appearing alternatingly with respect to the surface plane.

13. The composite material according to claim 9, wherein the foil-type strip regions are not coated.

14. The composite material according to claim 9, wherein the foil-type strip regions are coated with metal on at least one side.

15. The composite material according to claim 9, wherein the foil-type strip regions are coated on at least one side and this gives the composite material a conductivity and/or an antimicrobial effectiveness.

16. A method for producing a composite material, the composite material comprising at least one nonwoven fabric and a reinforcing material, thermally connected to it, situated in the form of regularly recurring patterns, which is derived from sheeting made of thermoplastic material, the method including the steps:
a) the combination of at least one fiber sheet with one shrinkable sheet made of thermoplastic material;
b) thermal heat sealing of the fiber sheet to the shrinkable sheet in the form of a regularly recurring pattern;
c) heating of the composite obtained during or after step b) to a temperature at which the nonwoven fabric develops, the shrinkage of the shrinkable sheet is released, and elevations and depressions form that appear regularly, alternatingly with respect to the surface plane; and
d) stretching of the composite in at least one direction, so that the elevations and depressions essentially disappear and the sheeting tears at the locations not heat sealed to the nonwoven fabric.

17. The method according to claim 16, wherein the heat seal of the fiber sheet to the shrinkable sheeting is performed by passing the composite through a calender which has at least one smooth and one engraved roll.

18. The method according to claim 17, wherein the engraved roll has regularly recurring patterns in the form of uninterrupted elevations, which are imaged as depressions in the composite material after calendering.

19. The method according to claim 18, wherein the uninterrupted elevations of the engraved roll are straight or curved or bent lines which are aligned parallel to one another.

20. The method according to claim 17, wherein the engraved roll is made up of at least two series of elevations, uninterrupted, regularly recurring and aligned parallel to one another, which form an angle to one another.

21. The method according to claim 18, wherein the regularly recurring patterns in the form of regularly situated lines are designed in the shape of hexagons.

22. A composite material comprising at least one nonwoven fabric and a reinforcing material, thermally connected to it, situated in the form of regularly recurring patterns, which is derived from sheeting made of thermoplastic material, wherein the composite material is used for at least one of an operating room coat, a textile outer materials for one-time use and a belt.

23. A composite material comprising at least one nonwoven fabric and a reinforcing material, thermally connected to it, situated in the form of regularly recurring patterns, which is derived from sheeting made of thermoplastic material, wherein the composite material is used in the hygienics and/or medical fields, especially for packaging or covering absorbent products.

24. The composite material according to claim 23, wherein the absorbent products are diapers or feminine hygiene products.
